(19) United States
(12) Patent Application Publication
(10) Pub. No.: US 2026/0222379 A1
(43) Pub. Date: Jul. 30, 2026

(54) METHOD, APPARATUS, DEVICE AND MEDIUM FOR MANAGING DATA PROCESSING SYSTEM

(71) Applicant: Beijing Zitiao Network Technology Co., Ltd., Beijing (CN)

(72) Inventors: Yujian Kang, Beijing (CN); Wei Zhao, Beijing (CN)

(21) Appl. No.: 19/171,077

(22) Filed: Apr. 4, 2025

Related U.S. Application Data
(63) Continuation of application No. PCT/CN2025/075498, filed on Jan. 27, 2025.

(51) Int. Cl. H04L 51/226; H04L 51/10

(52) U.S. Cl. CPC H04L 51/226; H04L 51/10

(57) ABSTRACT

A method, a device, and a medium for managing a data processing system are provided. A set of messages is obtained from a message queue of the data processing system, and respectively corresponds to a set of data items in the data processing system. A delay time corresponding to the set of messages is determined, the delay time indicating a query time for querying a processing state of the set of data items in at least one processing node in the data processing system. Based on the delay time, at least one querier in the data processing system is started, the set of data items is processed by the at least one processing node, and at least one querier is configured to query the processing state of the set of data items in the at least one processing node. The data processing system is managed based on the processing state.

### CROSS REFERENCE

This application is a continuation of and claims priority to PCT Application No. PCT/CN 2025/075498, filed on Jan. 27, 2025, and entitled “METHOD, APPARATUS, DEVICE AND MEDIUM FOR MANAGING DATA PROCESSING SYSTEM”, the entirety of which is incorporated herein by reference.

### FIELD

Implementations of the disclosure generally relate to computer technologies, and in particular, to a method, an apparatus, a device, and a computer-readable storage medium for managing a data processing system.

### BACKGROUND

A data processing system may process multiple types of data items, the data processing system may include a plurality of processing nodes, and the data item may pass through the plurality of processing nodes respectively and generate a final processing result. At this time, a data processing link is long. During data processing, it is desirable to query a processing state of the data item at respective processing nodes. Currently, it has been proposed that a state of respective data items is determined based on a check point, however, this technical solution requires modification of the code and results in higher complexity of the data processing system. At this time, it is desirable to determine the processing state of the data item in a simpler and efficient mode, thereby managing the data processing system.

### SUMMARY

In a first aspect of the disclosure, a method for managing a data processing system is provided. In the method, a set of messages is obtained from a message queue of the data processing system, the set of messages respectively corresponding to a set of data items in the data processing system. A delay time corresponding to a set of messages is determined, the delay time indicating a query time for querying a processing state of the set of data items in at least one processing node in the data processing system. Based on the delay time, at least one querier in the data processing system is started, the set of data items is processed by the at least one processing node, and at least one querier is configured to query the processing state of the set of data items in the at least one processing node. The data processing system is managed based on the processing state.

In a second aspect of the disclosure, an apparatus for managing a data processing system is provided. The apparatus includes: an obtaining module configured to obtain a set of messages from a message queue of the data processing system, the set of messages respectively corresponding to a set of data items in the data processing system; a determining module configured to determine a delay time corresponding to the set of messages, the delay time indicating a query time for querying a processing state of the set of data items in at least one processing node in the data processing system; a starting module configured to start at least one querier in the data processing system based on the delay time, the set of data items being processed by the at least one processing node, and the at least one querier being configured to query the processing state of the set of data items in the at least one processing node; and a managing module configured to manage the data processing system based on the processing state.

In a third aspect of the disclosure, an electronic device is provided. The electronic device includes: at least one processor; and at least one memory coupled to the at least one processor and storing instructions for execution by the at least one processor, the instructions, when executed by the at least one processor, causing the electronic device to perform the method according to the first aspect of the disclosure.

In a fourth aspect of the disclosure, there is provided a computer-readable storage medium having stored thereon a computer program which, when executed by a processor, causes the processor to implement the method according to the first aspect of the disclosure.

In a fifth aspect of the disclosure, there is provided a computer program product, including a computer program, wherein the computer program, when executed by a processor, implements the method according to the first aspect of the disclosure.

It should be understood that the content described in this disclosure is not intended to limit key features or major features of implementations of the disclosure, nor is it intended to limit the scope of the disclosure. Other features of the disclosure will become readily understood from the following description.

### BRIEF DESCRIPTION OF DRAWINGS

The above and other features, advantages, and aspects of various implementations of the disclosure will become more apparent from the following detailed description taken in conjunction with the accompanying drawings. In the drawings, the same or similar reference numbers refer to the same or similar elements, wherein:

FIG. 1 illustrates a block diagram of an application environment according to an implementation of the disclosure;

FIG. 2 illustrates a block diagram for managing a data processing system according to some implementations of the disclosure;

FIG. 3 illustrates a block diagram of obtaining a message queue according to some implementations of the disclosure;

FIG. 4 illustrates a block diagram of a data processing system managed by a producer and a consumer based on a message queue according to some implementations of the disclosure;

FIG. 5 illustrates a block diagram of a processing state of querying a data item according to some implementations of the disclosure;

FIG. 6 illustrates a block diagram of a state of a data processing system according to some implementations of the disclosure;

FIG. 7 illustrates a block diagram of a state of a data processing system according to some implementations of the disclosure;

FIG. 8 illustrates a flowchart of a method for managing a data processing system according to some implementations of the disclosure;

FIG. 9 illustrates a block diagram of an apparatus for managing a data processing system according to some implementations of the disclosure; and

FIG. 10 illustrates a block diagram of a device capable of implementing various implementations of the disclosure.

### DETAILED DESCRIPTION

Implementations of the disclosure will be described in more detail below with reference to the accompanying drawings. While certain implementations of the disclosure are shown in the accompanying drawings, it should be understood that the disclosure may be implemented in various forms and should not be construed as limitation to the implementations set forth herein, but rather, these implementations are provided for a more thorough and complete understanding of the disclosure. It should be understood that the drawings and implementations of the disclosure are for illustrative purposes only and are not intended to limit the scope of the disclosure.

In the description of implementations of the disclosure, the term “include” and similar terms should be understood as open-ended inclusion, i.e., “including but not limited to”. The term “based on” should be understood as “based at least in part on”. The terms “an implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, before the technical solutions disclosed in the embodiments of the disclosure are used, the types of personal information related to the disclosure, the usage scope, the usage scenario and the like should be notified to the user in an appropriate mode according to the relevant laws and regulations, and the authorization therefor should be obtained from the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as an electronic device, an application, a server and a storage medium executing the operation of the technical solution of the disclosure according to the prompt information.

As an optional but non-limiting implementation, in response to receiving an active request of the user, a manner of sending prompt information to the user may be, for example, in a manner of a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and a process for obtaining a user authorization is merely illustrative, and does not constitute a limitation on implementations of the disclosure, and other manners of meeting related laws and regulations may also be applied to implementations of the disclosure.

The term “in response to” as used herein means a state in which a respective event occurs or condition is satisfied. It will be appreciated that the timing of execution of a subsequent action performed in response to the event or condition is not necessarily strongly correlated with the time at which the event occurs or the condition is established. For example, in some cases, subsequent actions may be performed immediately when an event occurs or a condition is established; while in other cases, subsequent actions may be performed after a period of time elapses after an event occurs or a condition is established.

### Example Environment

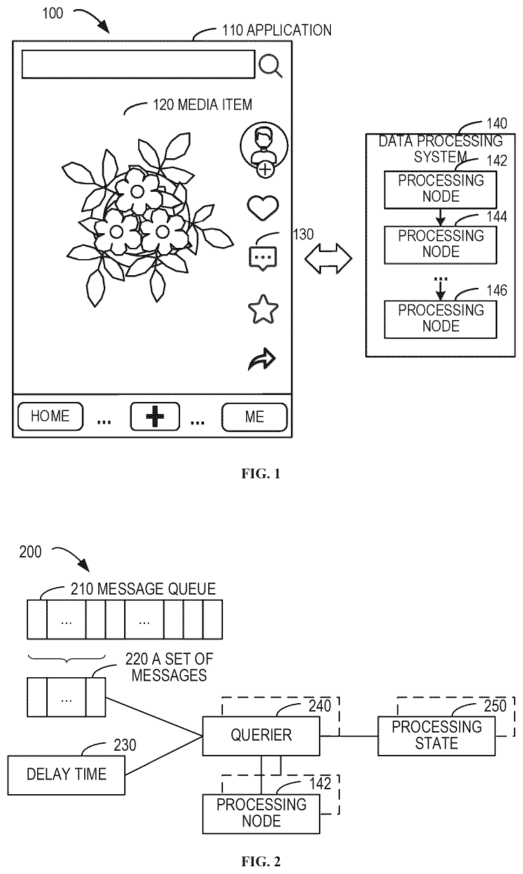

The data processing system may process multiple types of data items, the data processing system may include a plurality of processing nodes, and the data item may pass through the plurality of processing nodes respectively and generate a final processing result. At this time, the data processing link is long, and it is desirable to query a processing state of the data item at respective processing nodes. An application environment of the disclosure is described with reference to FIG. 1, FIG. 1 illustrates a block diagram 100 of the application environment according to an implementation of the disclosure. As shown in FIG. 1, a user may submit a data item to a data processing system 140 via an application 110. The application 110 may present a media item 120, which may include multiple types, including, but not limited to, a video, a short video, a music, a text, an image, a game, or rich media data including a combination of the above multiple types. The application 110 may provide a control 130 that may be clicked by the user to provide comments about the media item. Here, the comment and the media item provided in the application 110 may be collectively referred to as a data item.

The data processing system 140 may receive the data item and utilize the plurality of processing nodes 142, 144, . . . , 146 to process the respective data items. In the data processing system, the data item will pass through a plurality of processing nodes. To improve the operational efficiency of the data processing system, it is desirable to determine a state of the data item in the data processing system. It has been currently proposed that a state of respective data items is determined based on a check point, however, this technical solution requires modification of the code and increases the complexity of the data processing system. At this time, it is desirable to determine the processing state of the data item in a simpler and efficient mode, thereby managing the data processing system.

### Summary of System Management

In order to at least partially solve the deficiencies in the prior art, according to one implementation of the disclosure, a method for managing a data processing system is provided. A summary according to one implementation of the disclosure is described with reference to FIG. 2, and FIG. 2 illustrates a block diagram 200 for managing a data processing system according to some implementations of the disclosure. As shown in FIG. 2, a set of messages 220 may be obtained from a message queue 210 of the data processing system. Here, the set of messages may include one or more messages, and the set of messages respectively correspond to a set of data items in the data processing system. In the context of the disclosure, a set of “XX” may include one or more “XX” . For example, the set of messages may include one or more messages, that is, at least one message. Assuming that the message queue 210 includes N messages, a first set of messages may include N1 messages, a second set of messages may include N2 messages, and the like.

For ease of description, a specific management process will be described by taking a media sharing system as an example of the data processing system. At this point, the data items may include a media item published by an object (e.g., a user) in the media sharing system, and/or a comment for the media item published by the object in the media sharing system. With some implementations of the disclosure, multiple different types of data items may be processed in a similar mode, thereby managing the data processing system in a simpler and efficient mode.

The message queue 210 may include at least one set of messages, and each set of messages may have its own delay time. A delay time corresponding to a set of messages may be determined, and the delay time indicates a query time for querying a processing state of a set of data items in the at least one processing node in the data processing system. Here, the data processing system may include a set of processing nodes, and respective processing node may be invoked in a predetermined order. For example, the delay time of the first set of messages may be represented as ΔT₁, the delay time of the second set of messages may be represented as ΔT₂, and the like.

The data processing system 140 may include at least one querier 240, one querier may query the processing state of the data item in one processing node. Assuming that the data processing system includes M processing nodes, there may be M queriers corresponding to the M processing nodes, respectively. Further, the at least one querier 240 in the data processing system may be started based on the delay time 230. A set of data items is processed by the at least one processing node, and the at least one querier is used to query a processing state 250 of the set of data items in the at least one processing node. The data processing system may be managed based on the processing state 250. For example, a bottleneck in the data processing system, a workload of respective processing node, etc. may be determined based on the processing state, thereby optimizing the data processing system.

With some implementations of the disclosure, the delay time may specify a time point during the running process of the system, and querying the processing state of the data item may be initiated at a specified time point. In this way, a running state of the data processing system may be detected in real-time.

### Detailed Process of System Management

Having described a summary according to some implementations of the disclosure, more details regarding a method for managing a data processing system will be described below. According to some implementations of the disclosure, messages may be continuously received from the message queue during running of the data processing system 140. The message is generated based on the data item in the data processing system. Specifically, the user may submit a media item to a data system 140 via an application, and respective processing nodes in the data processing system 140 may process the received media item. For example, the comment is used as just an example of the data item, the data processing system 140 may receive the submitted comment, one processing node may verify whether the user has authority to publish the comment, one processing node may write the comment into a database, one processing node may verify whether contents of the comment meets a predetermined requirement (for example, whether the number of words of the comment satisfies a predetermined range, etc.), one processing node may publish the comment, and the like.

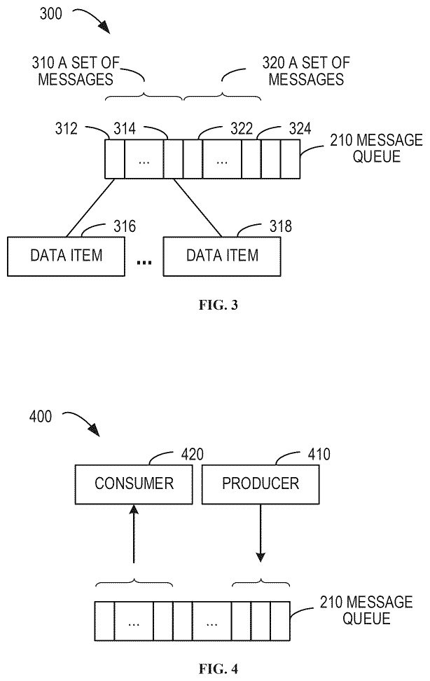

According to some implementations of the disclosure, the message queue may be determined based on the following mode. Specifically, the data item may be received from a client device connected to the data processing system; a message may be generated based on the data item, the message including an identifier of the data item and attribute information associated with the data item, and the message is added to the message queue. More details regarding the message queue are described with reference to FIG. 3, FIG. 3 illustrates a block diagram 300 of obtaining a message queue according to some implementations of the disclosure. As shown in FIG. 3, one message may correspond to one data item, e.g., a message 312 may be generated based on a data item 316, . . . , a message 314 may be generated based on a data item 318.

According to some implementations of the disclosure, the message may include multiple dimensions: an identifier of the data item, and relevant information about the user publishing the data item (e.g., an identifier of the user, an identifier of a client device used by the user, etc.). It should be understood that the data processing system may have a distributed architecture and the received data items may come from different regions, thus requiring a global unique identifier of the data items to be determined in order to accurately distinguish each data item.

According to some implementations of the disclosure, a grouping mode of the message queue may be described by using configuration information. For example, N1 messages in the message queue may be specified to be divided into a first set of messages, N2 messages in the message queue may be specified to be divided into a second set of messages, and the like. Alternatively and/or additionally, the configuration information may specify that respective sets include a same quantity (e.g., M) of messages.

According to some implementations of the disclosure, a corresponding message may be generated for each received data item, and the message queue includes a plurality of messages corresponding to all data items. Alternatively and/or additionally, a portion of the data items may be selected randomly from the received data items and a corresponding message is generated for the selected portion of the data items. For example, a portion of the data items may be selected at a predetermined time interval, or in a predetermined proportion. In this way, with a large amount of data, it is not necessary to note that each data item is processed, but a representative data item may be selected to generate a message.

According to some implementations of the disclosure, configuration information for describing a grouping mode of the message queue may be obtained, and a set of messages may be obtained from the message queue based on the configuration information. The configuration information may be stored in a variety of ways, for example, the configuration information may be stored separately from the message queue. Specifically, the quantity of messages included in each set may be specified in a separate file. Alternatively and/or additionally, the configuration information may be added in the message queue. Specifically, a group identifier may be set for respective message in the message queue. For example, the first to Mth messages in the message queue may have a group identifier 1, the (M+1)th to 2Mth messages in the message queue may have a group identifier 2, and the like. With some implementations of the disclosure, a desired quantity of messages may be extracted from the message queue in a predetermined mode, thereby determining a state of the data processing system.

According to some implementations of the disclosure, the quantity of messages in a set may be set based on a performance of the data processing system. The higher the performance of the data processing system, the greater the quantity of messages. Alternatively and/or additionally, the quantity of messages in the set may be set based on the quantity of data items in the data processing system. The larger the quantity of data items, the larger the quantity of messages. In this way, a corresponding state may be detected in a mode of more closely matching with the performance of the data processing system.

According to some implementations of the disclosure, a set of messages may have a corresponding delay time. As shown in FIG. 3, a set of messages may include messages 312, . . . , and 314, and a delay time thereof may be 1 minute. According to some implementations of the disclosure, the message queue may include a plurality of sets of messages, and the plurality of sets of messages respectively correspond to a plurality of different delay times. With continued reference to FIG. 3, a set of messages 320 may include messages 322, . . . , and 324 generated based on other data items, and a delay time thereof may be 2 minutes, etc. With some implementations of the disclosure, a state of data items corresponding to different message sets may be queried among different time points, thereby avoiding resource shortage due to simultaneous execution of a large number of queries.

According to some implementations of the disclosure, the delay time of respective message sets may be specified in the configuration information. For example, the configuration information may specify a delay time of the first set of messages as ΔT₁, a delay time of the second set of messages as ΔT₂, and the like Alternatively and/or additionally, the configuration information may specify an interval between the delay times of two successive sets as ΔT. For example, ΔT may be specified as being equal to 1 minute, and at this time, the delay times of the respective sets are 1 minute, 2 minutes, 3 minutes, and so on, respectively. Alternatively and/or additionally, information about the delay time may be added in the message queue.

According to some implementations of the disclosure, the data processing system may operate in an asynchronous mode. Specifically, updating of the message queue may be independent of the processing of respective data items, see FIG. 4 for more details. FIG. 4 illustrates a block diagram 400 of a data processing system managed by a producer and a consumer based on a message queue, in accordance with some implementations of the disclosure. According to some implementations of the disclosure, the producer 410 and the consumer 420 may be implemented with an application and may be deployed to any device in the data processing system having computing capabilities.

As shown in FIG. 4, a message may be added to the tail of the message queue by the producer 410, and a message may be obtained by the consumer 420 from the head of the message queue. In response to determining that at least one querier is started, a set of messages is removed from the message queue. As the data processing system runs, messages in the message queue 210 may constantly change, and thus a processing state of respective latest data items may be determined in real time, thereby managing the running of the data processing system in real time.

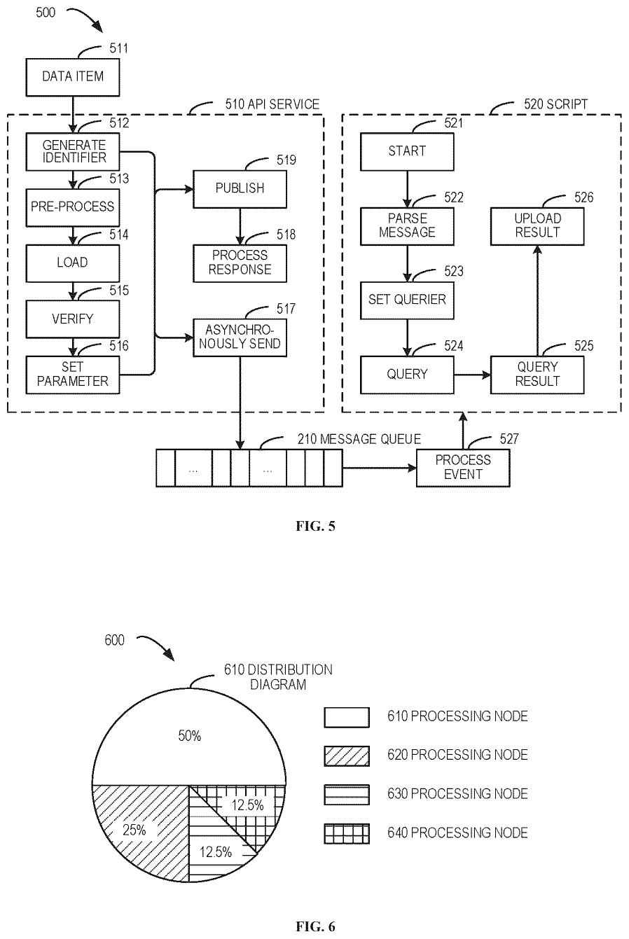

According to some implementations of the disclosure, the producer 410 may be implemented by an API service in the data processing system, and the consumer 420 may be implemented by a script. Further details are described with reference to FIG. 5, FIG. 5 illustrates a block diagram 500 of querying a processing state of a data item according to some implementations of the disclosure. As shown in FIG. 5, a data item 511 from an application may be received by an API service 510. At block 512, a globally unique identifier may be generated for the data item and a message may be generated. At block 513, pre-processing may be performed, for example, it may be determined whether the user has authority to publish a comment, and the like. At block 514, the data item may be loaded to a database. At block 515, it may be verified whether the data item meets a predetermined condition. At block 516, a parameter required for publishing the comment may be set. At block 519, the data item may be published; and at block 518, a corresponding response data may be processed. According to some implementations of the disclosure, the above processes may be performed by different processing nodes in the data processing system.

Alternatively and/or additionally, the generated message may be sent to the message queue 210 in an asynchronous mode at block 517. The data processing system may continually receive data items from client devices of various users and continually add messages to be processed to the tail of the message queue 210.

The script 520 may consume a message in the message queue 210 as a consumer, and event processing may be performed at block 527. Specifically, the event processing process begins at block 521. At block 522, the message may be parsed according to the configuration information, for example, a set of messages may be extracted from the message queue 210 in a predetermined grouping mode, and a delay time corresponding to the set of messages is obtained. At block 523, a querier may be set based on the obtained delay time. At block 524, a query may be performed at a predetermined time point. At block 525, a query result may be obtained, e.g., a processing state of the data item in respective subsystems. Then, the obtained result may be uploaded at block 526.

According to some implementations of the disclosure, the technical solutions described above may be performed in a media sharing system. Specifically, the user may publish a comment, and an API service may generate a unique comment ID, and perform processes such as preprocessing, loading, and checking for the comment, and then publish the comment. In parallel with the above process, the API service may generate a corresponding message based on the unique comment ID and send the message to the message queue. The message may include a comment ID, and a client parameter (such as a user parameter, a device parameter, etc.) for publishing the comment.

According to some implementations of the disclosure, in a process of sending a message to a message queue, configuration information may be obtained and a plurality of messages may be divided into one or more sets based on the configuration information, and a delay time of the message(s) in each set is set. Alternatively and/or additionally, the sets may be divided and the delay time of the message(s) in each set may be set in a process of reading the message from the message queue. Specifically, a first set of messages may be delayed for 1 minute, a second set of messages may be delayed for 2 minutes, and a third set of messages may be delayed for 3 minutes, etc. After obtaining the message, the script may query respective processing node, for example, query whether the comment exists in a database of comments, whether the comment is successfully verified, whether the comment is successfully sent, and the like.

According to some implementations of the disclosure, a query result may be presented through a visualization panel. Since the published comments are divided into a plurality of sets, the delay times for respective sets are different, so that a state of each comment at different time points (e.g., 1 minute, 2 minutes, 3 minutes, etc.) may be seen: for example, how many comments are stored to the database, how many comments are successfully verified, how many comments are successfully published, and so on. More information about presenting the query result is described with reference to FIG. 6, FIG. 6 illustrates a block diagram 600 of a state of a data processing system according to some implementations of the disclosure.

As shown in FIG. 6, in a process of managing the data processing system based on the processing state, a distribution of a plurality of data items in the data processing system at the at least one processing node may be determined based on the processing state. Different example figures represent different processing nodes. Assuming that the data processing system includes 4 processing nodes, and a distribution diagram 610 may represent a proportion of data items at 4 processing nodes. For example, about 50% of the data items are located at a processing node 610, about 25% of the data item is located at a processing node 620, about 12.5% of the data items is located at a processing node 630, and about 12.5% of the data items is located at a processing node 640. With some implementations of the disclosure, the distribution of data items at various processing nodes may be clearly understood, thereby facilitating finding a processing node at which a processing bottleneck may be generated.

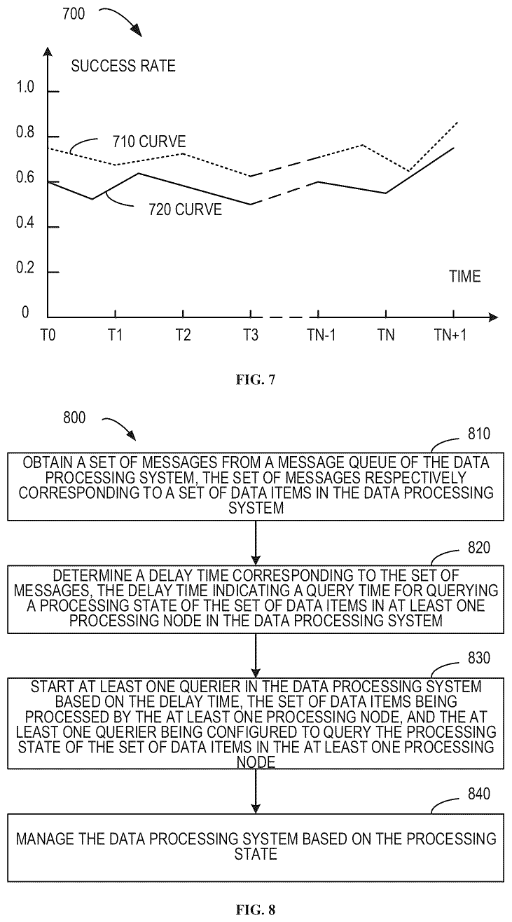

According to some implementations of the disclosure, in a process of managing a data processing system based on a processing state, a processing state of a plurality of data items in the data processing system at different time points may be determined based on the processing state. Further details are described with reference to FIG. 7, FIG. 7 illustrates a block diagram 700 of a state of a data processing system according to some implementations of the disclosure. As shown in FIG. 7, an abscissa represents a time, and an ordinate represents a success rate in the processing node, e.g., a proportion of being successfully written into the database. Curves 710 and 720 may, for example, represent processing states of different types of data items. The curve 710 may correspond to a comment, and the curve 720 may correspond to a media item. With some implementations of the disclosure, a plurality of queriers may be utilized to respectively query processing states (e.g., processed/unprocessed) of data items in a plurality of processing nodes. In this way, the performance of respective processing nodes may be monitored, thereby determining whether the respective processing nodes satisfy the expected performance.

According to some implementations of the disclosure, in a process of managing the data processing system based on the processing state, a node state of at least one processing node may be determined based on the processing state. Specifically, if a proportion of successfully processed data items at a certain processing node is much lower than a proportion of successfully processed data items at other processing nodes, it may be considered that the processing node is a bottleneck that affects the overall performance of the data processing system. Alternatively and/or additionally, it may be considered that the processing node may be abnormal, and may further test whether a function of the processing node is normal. With some implementations of the disclosure, it is not necessary to run a specialized diagnostic program, but an abnormality in the processing node may be detected by a processing window of the data item.

With some implementations of the disclosure, the delay time may specify a time point during the running process of the system, and the processing state of the data item may be queried at the specified time point. In this way, a running state of the data processing system may be detected in real-time.

### Example Process

FIG. 8 illustrates a flowchart of a method 800 for managing a data processing system according to some implementations of the disclosure. At block 810, a set of messages is obtained from a message queue of the data processing system, the set of messages respectively corresponding to a set of data items in the data processing system. At block 820, a delay time corresponding to the set of messages is determined, the delay time indicating a query time for querying a processing state of the set of data items in at least one processing node in the data processing system. At block 830, at least one querier in the data processing system is started based on the delay time, the set of data items being processed by the at least one processing node, and at least one querier being configured to query the processing state of the set of data items in the at least one processing node. At block 840, the data processing system is managed based on the processing state.

According to some implementations of the disclosure, the method 800 further includes: removing the set of messages from the message queue in response to determining that the at least one querier is started.

According to some implementations of the disclosure, obtaining the set of messages includes: obtaining configuration information for describing a grouping mode of the message queue; and obtaining the set of messages from the message queue based on the configuration information.

According to some implementations of the disclosure, the message queue includes a plurality of sets of messages, and the plurality of sets of messages correspond to a plurality of different delay times respectively.

According to some implementations of the disclosure, the message queue is determined by: receiving a data item from a client device connected to the data processing system; generating a message based on the data item, the message including an identifier of the data item and attribute information associated with the data item; and adding the message to the message queue.

According to some implementations of the disclosure, managing the data processing system based on the processing state includes: determining a node state of the at least one processing node based on the processing state.

According to some implementations of the disclosure, managing the data processing system based on the processing state includes: determining a distribution of a plurality of data items in the data processing system at the at least one processing node based on the processing state.

According to some implementations of the disclosure, managing the data processing system based on the processing state includes: determining a processing state of a plurality of data items in the data processing system among different time points based on the processing state.

According to some implementations of the disclosure, the data processing system is a media sharing system, and the data items include: a media item published by an object in the media sharing system, and/or a comment for a media item published by the object in the media sharing system.

### Example Apparatus and Device

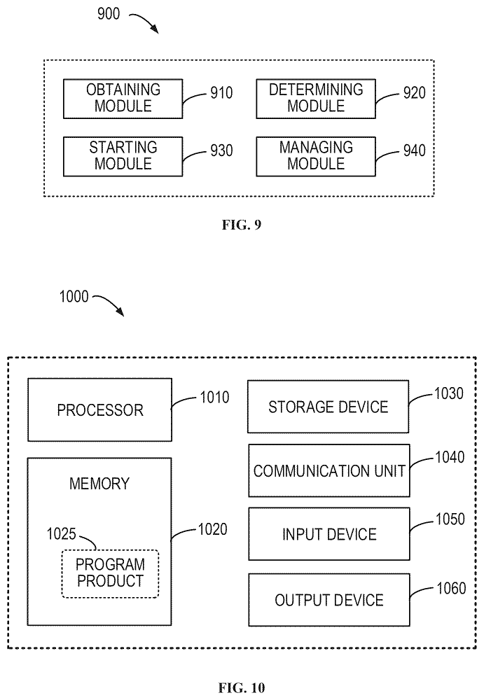

FIG. 9 illustrates a block diagram of an apparatus 900 for managing a data processing system according to some implementations of the disclosure. The apparatus 900 includes: an obtaining module 910 configured to obtain a set of messages from a message queue of the data processing system, the set of messages respectively corresponding to a set of data items in the data processing system; a determining module 920 configured to determine a delay time corresponding to the set of messages, the delay time indicating a query time for querying a processing state of the set of data items in at least one processing node in the data processing system; a starting module 930 configured to start at least one querier in the data processing system based on the delay time, the set of data items being processed by the at least one processing node, and the at least one querier being configured to query the processing state of the set of data items in the at least one processing node; and a managing module 940 configured to manage the data processing system based on the processing state.

According to some implementations of the disclosure, the apparatus 900 further includes a processing module configured to: remove the set of messages from the message queue in response to determining that the at least one querier is started.

According to some implementations of the disclosure, the obtaining module is further configured to: obtain configuration information for describing a grouping mode of the message queue; and obtain the set of messages from the message queue based on the configuration information.

According to some implementations of the disclosure, the message queue includes a plurality of sets of messages, and the plurality of sets of messages correspond to a plurality of different delay times respectively.

According to some implementations of the disclosure, the message queue is determined by: receiving a data item from a client device connected to the data processing system. generating a message based on the data item, the message including an identifier of the data item and attribute information associated with the data item; and adding the message to the message queue.

According to some implementations of the disclosure, the managing module is further configured to determine a node state of the at least one processing node based on the processing state.

According to some implementations of the disclosure, the managing module is further configured to determine a distribution of a plurality of data items in the data processing system at the at least one processing node based on the processing state.

According to some implementations of the disclosure, the managing module is further configured to: determine a processing state of a plurality of data items in the data processing system among different time points based on the processing state.

According to some implementations of the disclosure, the data processing system is a media sharing system, and the data item includes a media item published by an object in the media sharing system, and/or a comment for a media item published by the object in the media sharing system.

FIG. 10 illustrates a block diagram of a device 1000 capable of implementing various implementations of the disclosure. It should be understood that a computing device 1000 shown in FIG. 10 is merely illustrative and should not constitute any limitation on the functionality and scope of the implementations described herein. The computing device 1000 shown in FIG. 10 may be configured to implement the method described above.

As shown in FIG. 10, the computing device 1000 is in a form of a general-purpose computing device. Components of the computing device 1000 may include, but are not limited to, one or more processors 1010, a memory 1020, a storage device 1030, one or more communication units 1040, one or more input devices 1050, and one or more output devices 1060. The processor 1010 may be an actual or virtual processor and capable of performing various processes according to programs stored in the memory 1020. In a multiprocessor system, the processors execute computer-executable instructions in parallel to improve the parallel processing capability of the computing device 1000.

The computing device 1000 generally includes a plurality of computer storage media. Such media may be any available media accessible by the computing device 1000, including, but not limited to, volatile and non-volatile media, removable and non-removable media. The memory 1020 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 1030 may be a removable or non-removable medium and may include a machine-readable medium, such as a flash drive, a magnetic disk, or any other medium, which may be capable of storing information and/or data (e.g., training data for training) and may be accessed within the computing device 1000.

The computing device 1000 may further include additional removable/non-removable, volatile/non-volatile storage media/medium. Although not shown in FIG. 10, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 1020 may include a computer program product 1025 having one or more program modules configured to perform various methods or actions of various implementations of the disclosure.

The communications unit 1040 implements communications with other computing devices through a communications medium. Additionally, the functionality of components of the computing device 1000 may be implemented in a single computing cluster or multiple computing machines capable of communicating through a communication connection. Thus, the computing device 1000 may operate in a networked environment using logical connection(s) with one or more other servers, a network personal computer (PC), or another network node.

The input device 1050 may be one or more input devices, such as a mouse, a keyboard, a trackball, or the like. The output device 1060 may be one or more output devices, such as a display, a speaker, a printer, or the like. The computing device 1000 may also communicate with one or more external devices (not shown) as needed, the external device such as a storage device, a display device, or the like, communicates with one or more devices that enable a user to interact with the computing device 1000, or communicates with any device (e.g., a network card, a modem, etc.) that enables the computing device 1000 to communicate with one or more other computing devices. Such communication may be performed via an input/output (I/O) interface (not shown).

According to an implementation of the disclosure, there is provided a computer-readable storage medium having computer-executable instructions stored thereon, and the computer-executable instructions are executed by a processor to implement the method described above. According to an implementation of the disclosure, a computer program product is further provided, the computer program product being tangibly stored on a non-transitory computer-readable medium and including computer-executable instructions, and the computer-executable instructions being executed by a processor to implement the method described above. According to an implementation of the disclosure, there is provided a computer program product having stored thereon a computer program, which, when executed by a processor, implements the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processor of a general purpose computer, special purpose computer, or other programmable data processing apparatus to produce a machine, such that the instructions, when executed by a processor of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowcharts and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for managing a data processing system, comprising:
obtaining a set of messages from a message queue of the data processing system, the set of messages respectively corresponding to a set of data items in the data processing system;
determining a delay time corresponding to the set of messages, the delay time indicating a query time for querying a processing state of the set of data items in at least one processing node in the data processing system;
starting at least one querier in the data processing system based on the delay time, the set of data items being processed by the at least one processing node, and the at least one querier being configured to query the processing state of the set of data items in the at least one processing node; and
managing the data processing system based on the processing state.

2. The method of claim 1, further comprising:
removing the set of messages from the message queue in response to determining that the at least one querier is started.

3. The method of claim 1, wherein obtaining the set of messages comprises:
obtaining configuration information for describing a grouping mode of the message queue; and
obtaining the set of messages from the message queue based on the configuration information.

4. The method of claim 1, wherein the message queue comprises a plurality of sets of messages, and the plurality of sets of messages correspond to a plurality of different delay times respectively.

5. The method of claim 1, wherein the message queue is determined by:
receiving a data item from a client device connected to the data processing system;
generating a message based on the data item, the message comprising an identifier of the data item and attribute information associated with the data item; and
adding the message to the message queue.

6. The method of claim 1, wherein managing the data processing system based on the processing state comprises:
determining a node state of the at least one processing node based on the processing state.

7. The method of claim 1, wherein managing the data processing system based on the processing state comprises:
determining a distribution of a plurality of data items in the data processing system at the at least one processing node based on the processing state.

8. The method of claim 1, wherein managing the data processing system based on the processing state comprises:
determining a processing state of a plurality of data items in the data processing system among different time points based on the processing state.

9. The method of claim 1, wherein the data processing system is a media sharing system, and the data item comprises: a media item published by an object in the media sharing system, and/or a comment for a media item published by the object in the media sharing system.

10. An electronic device, comprising:
at least one processor; and
at least one memory coupled to the at least one processor and storing instructions for execution by the at least one processor, the instructions, when executed by the at least one processor, causing the electronic device to perform acts comprising:
obtaining a set of messages from a message queue of the data processing system, the set of messages respectively corresponding to a set of data items in the data processing system;
determining a delay time corresponding to the set of messages, the delay time indicating a query time for querying a processing state of the set of data items in at least one processing node in the data processing system;
starting at least one querier in the data processing system based on the delay time, the set of data items being processed by the at least one processing node, and the at least one querier being configured to query the processing state of the set of data items in the at least one processing node; and
managing the data processing system based on the processing state.

11. The electronic device of claim 10, wherein the acts further comprise:
removing the set of messages from the message queue in response to determining that the at least one querier is started.

12. The electronic device of claim 10, wherein obtaining the set of messages comprises:
obtaining configuration information for describing a grouping mode of the message queue; and
obtaining the set of messages from the message queue based on the configuration information.

13. The electronic device of claim 10, wherein the message queue comprises a plurality of sets of messages, and the plurality of sets of messages correspond to a plurality of different delay times respectively.

14. The electronic device of claim 10, wherein the message queue is determined by:
receiving a data item from a client device connected to the data processing system;
generating a message based on the data item, the message comprising an identifier of the data item and attribute information associated with the data item; and
adding the message to the message queue.

15. The electronic device of claim 10, wherein managing the data processing system based on the processing state comprises:
determining a node state of the at least one processing node based on the processing state.

16. The electronic device of claim 10, wherein managing the data processing system based on the processing state comprises:
determining a distribution of a plurality of data items in the data processing system at the at least one processing node based on the processing state.

17. The electronic device of claim 10, wherein managing the data processing system based on the processing state comprises:
determining a processing state of a plurality of data items in the data processing system among different time points based on the processing state.

18. The electronic device of claim 10, wherein the data processing system is a media sharing system, and the data item comprises: a media item published by an object in the media sharing system, and/or a comment for a media item published by the object in the media sharing system.

19. A non-transitory computer-readable storage medium having stored thereon computer instructions that, when executed by a processor, cause the processor to perform acts comprising:
obtaining a set of messages from a message queue of the data processing system, the set of messages respectively corresponding to a set of data items in the data processing system;
determining a delay time corresponding to the set of messages, the delay time indicating a query time for querying a processing state of the set of data items in at least one processing node in the data processing system;
starting at least one querier in the data processing system based on the delay time, the set of data items being processed by the at least one processing node, and the at least one querier being configured to query the processing state of the set of data items in the at least one processing node; and
managing the data processing system based on the processing state.

20. The non-transitory computer-readable storage medium of claim 19, wherein the acts further comprise:
removing the set of messages from the message queue in response to determining that the at least one querier is started.
